(19) United States
(12) Patent Application Publication
(10) Pub. No.: US 2014/0212563 A1
(43) Pub. Date: Jul. 31, 2014

(54) Stabilizer for Food Applications

(71) Applicant: J. RETTENMAIER & SÖHNE GMBH & CO. KG, Rosenberg (DE)

(72) Inventors: Georg Bache, Buhlertann (DE); Ralf Ungerer, Rainau (DE)

(73) Assignee: J. RETTENMAIER & SÖHNE GMBH & CO. KG, Rosenberg (DE)

(21) Appl. No.: 14/244,591

(22) Filed: Apr. 3, 2014

Related U.S. Application Data
(63) Continuation-in-part of application No. 13/318,606, filed on Feb. 16, 2012.

(30) Foreign Application Priority Data
May 26, 2009 (DE) 10 2009 022 738.5

(51) Int. Cl. A23L 1/0534

(52) U.S. Cl. CPC A23L 1/0534
USPC 426/573

(57) ABSTRACT

A compound comprises microcrystalline cellulose (MCC) in colloidal form and two different qualities of carboxymethyl cellulose (CMC), wherein the MCC and the two different qualities of CMC are combined by co-processing, wherein the two different qualities of CMC have different degrees of substitution (DS), wherein a low-substituted CMC is present with a DS of 0.6 to 0.9 and a high-substituted CMC is present with a DS of 1.10 to 1.45, wherein a percentage of CMC in the compound is between 5% and 18% by weight relating to a dry matter, and wherein the co-processing is done by homogenization.

### RELATED APPLICATIONS

This application is a Continuation-In-Part of U.S. application Ser. No. 13/318,606, filed Nov. 2, 2012, which is a U.S. national phase application, which is based on, and claims priority from, PCT application Serial No. PCT/EP2010/003127, filed May 21, 2010, which claims priority from foreign application Serial No. 10 2009 022 738.5, filed May 26, 2009, in Germany.

### BACKGROUND

The invention relates to the stabilization of food of all kinds. So-called stabilizing agents are used in the area of foodstuffs. They are intended to stabilize water-oil emulsions, i.e. they should prevent a separation of the two components. Stabilizers are also used to hold solids in suspension in aqueous systems, meaning that sedimentation is prevented.

Stabilizers are known and applied in a large variety. A group of stabilizers comprises a combination of colloidal microcrystalline cellulose (MCC) and carboxymethyl cellulose (CMC). These products are subjected in a wet process to a mechanical shearing process and transferred into the colloidal state. After combination with CMC, with which MCC enters into synergistic effects, drying towards the end product occurs. Reference is hereby made to U.S. Pat. No. 3,539,365.

The efficacy of presently available stabilizers is limited. Frequently, the properties desired by the user do not meet all requirements. Stabilizers are also limited with respect to the field of application. There are products that can only be used for milk products because they can be activated easily under the conditions prevailing there, e.g. under a high calcium content. That is why further hydrocolloids are added in addition to MCC and CMC to the known stabilization systems for increasing efficacy, for improved activation or for lower electrolyte capability, e.g. carrageen. There are reasons however why this additive cannot be used everywhere, e.g. reasons of production or declaration.

A further disadvantage of known additives consists in that the amount thereof has to be very high in order to be efficient. E.g. in order to stabilize cocoa particles in chocolate drinks it is necessary to us at least 0.5 percent additives. Moreover, the said additives necessitate an involved processing and preparation procedure. The invention is based on the object of providing a stabilizer which can be produced at low cost and easily, offers high efficacy, and achieves the desired success already in low quantities. This object is achieved by the features of the independent claims.

### SUMMARY

The invention is based on a dispersion of MCC and CMC. Specific proportions of CMC are advantageous and the degree of substitution (DS) of the two components plays an important role. Additionally, combining all species of MCC and CMC together at the same time by co-processing, and homogenizing the same, is a key for achieving the desired results.

### DETAILED DESCRIPTION

The stabilizers in accordance with the invention allow making do with low application quantities. 0.2% of the dispersion in accordance with the invention is sufficient to stabilize cocoa particles in milk for example. This means a very large increase in the efficacy and at the same time an improved activation capability. Additional additives are therefore superfluous. The increase in the efficacy can be proven by the usual rheological characteristic data such as by the storage modulus as shown in two different media such as milk or tap water for example.

In summary, the invention provides the following advantages: (1) Higher efficiency in the stabilization of emulsions or solids in aqueous systems, based on higher storage moduli (gel strength G′), (2) low required quantity of stabilizer, and (3) activation with low input of shear energy, high tolerance against factors which negatively influence the activation, e.g. electrolytes.

### Example 1

A stabilizing agent with the name MCG 0048 which is based on MCC and CMC and corresponds to the invention and three stabilizing agents offered on the market under the name AVICEL CL 611, AVICEL RC 591F and AVICEL plus GP3282 (with the latter additionally containing carrageen) are activated in line by means of a homogenizer at 200 bars in order to stabilize a cocoa beverage.

The MCC and the two species of CMC must be combined together at the same time, not separately, by co-processing. CMC I means a CMC of a first range of degree of substitution and CMC II means a CMC with a second range of degree of substitution, and so on. Thus, co-processing is used to combine MCC, CMC I, and CMC II together into one compound. This can be done by bringing the MCC, CMC I, and CMC II together in a waterous suspension, subjecting the waterous suspension to homogenizing, and thereby using high shear forces to create one compound.

The limit dosing was determined for all stabilizing agents in which no sediment is formed any more in the glass bottles in the stabilized cocoa beverage after 24 and 48 hours.

The entire procedure including evaluation is described (see Annex 2).

Exemplary recipe for cocoa beverage for MCG 0048

| | % | G |
|---|---|---|
| Stabilizing agent MCG 0048 | 0.1 | 1.00 |
| Sugar | 6.00 | 60.00 |
| Cocoa (CEBE) | 0.50 | 5.00 |
| Milk 1.5% fat | 93.4 | 934.0 |
| | 100.00 | 1000.00 |

Summary of application example of cocoa beverage:

The table provides a summary of the required dosing for stabilizing cocoa particles in low-fat milk of the samples treated according to Example 1:

| | Limit dosing for |
|---|---|
| | sufficient stabilization |
| | of the cocoa particles |
| AVICEL CL 611 | 0.6-0.7% |
| AVICEL RC 591F | 0.4-0.5% |
| AVICEL plus GP 3282 | 0.2-0.3% |
| (with proportion of carrageen) | |
| VITACELL MCG 0048 | 0.1-0.15% |

### Example 2

A stabilizing agent which corresponds to the invention and is based on MCC and CMC with the name MCG 0048 and two stabilizing agents available on the market with the name AVICEL CL 611, AVICEL RC591F are activated by various activation methods in different media (de-ionized water; 0.05% CaCl2; 0.1% CaCl2 and milk).

The MCC and the two species of CMC must be combined together at the same time, not separately, by co-processing. CMC I means a CMC of a first range of degree of substitution and CMC II means a CMC with a second range of degree of substitution. Thus, co-processing is used to combine MCC, CMC I, and CMC II together into one compound. This can be done by bringing the MCC, CMC I, and CMC II together in a waterous suspension, subjecting the waterous suspension to homogenizing, and thereby using high shear forces to create one compound.

The performance and the results are described in Test 1 and Test 2.

Test 1, activation in line in the homogenizer, at 200 bars, 3%. The entire procedure, including the evaluation, is described in Annex 1 and 3.

Measurement apparatus: Physika MCR 301

Measuring system: CC27

Measuring cell: C-PTD200, oscillation test

Gel formation “immediate measurement”; gel formation after 120 seconds

| Activated in | Sample | tan□ | G′ (Pa) |
|---|---|---|---|
| De-ionized water | AVICEL | | |
| | CL 611F | 0.843 | 1.61 |
| | AVICEL | | |
| | RC591 F | 0.122 | 21.70 |
| | VIVAPUR | | |
| | MCG 0048 | 0.134 | 51.77 |
| CaCl2 solution, | AVICEL | | |
| 0.05% | CL 611F | 0.936 | 1.11 |
| | AVICEL | | |
| | RC591 F | 0.137 | 15.42 |
| | VIVAPUR | | |
| | MCG 0048 | 0.106 | 33.15 |
| CaCl2 solution, | AVICEL | | |
| 0.1% | CL 611F | 0.689 | 1.61 |
| | AVICEL | | |
| | RC591 F | 0.222 | 7.63 |
| | VIVAPUR | | |
| | MCG 0048 | 0.092 | 29.02 |
| UHT-milk, 1.5% | AVICEL | | |
| fat | CL 611F | 0.407 | 9.06 |
| | AVICEL | | |
| | RC591 F | 0.258 | 15.10 |
| | VIVAPUR | | |
| | MCG 0048 | 0.122 | 51.93 |

Test 2, activation in the Waring Blender, 18,000 rpm, 2 min, 3%

The entire procedure, including evaluation, is described in Annex 1 and 4.

Measurement apparatus: Physika MCR 301

Measuring system: CC27

Measuring cell: C-PTD200, oscillation test

Gel formation “immediate measurement”; gel formation after 120 seconds

| Activated in | Sample | tan□ | G′ (Pa) |
|---|---|---|---|
| De-ionized water | AVICEL | | |
| | CL 611F | 1.151 | 0.93 |
| | AVICEL | | |
| | RC591 F | 0.156 | 18.45 |
| | VIVAPUR | | |
| | MCG 0048 | 0.142 | 49.00 |
| CaCl2 solution, | AVICEL | | |
| 0.05% | CL 611F | 1.169 | 0.64 |
| | AVICEL | | |
| | RC591 F | 0.194 | 11.63 |
| | VIVAPUR | | |
| | MCG 0048 | 0.113 | 31.24 |
| CaCl2 solution, | AVICEL | | |
| 0.1% | CL 611F | 1.120 | 0.63 |
| | AVICEL | | |
| | RC591 F | 0.355 | 4.09 |
| | VIVAPUR | | |
| | MCG 0048 | 0.100 | 26.88 |
| UHT-milk, 1.5% | AVICEL | | |
| fat | CL 611F | 0.522 | 5.31 |
| | AVICEL | | |
| | RC591 F | 0.314 | 11.28 |
| | VIVAPUR | | |
| | MCG 0048 | 0.144 | 41.81 |

In all examined media (different water qualities, milk) and in all examined activation methods the stabilizer in accordance with the invention shows higher storage moduli than the products available on the market.

A compound has proven to be especially useful and has the following properties: (1) it is present in the form of a gel, obtained by homogenizing a compound powder, and (2)it has gel strength of at least 25 Pa at 3% application concentration relating to the medium in which the compound is dispersed.

The following apparatuses are appropriately used:

Waring blender 1 L with glass top, 3%, 18,000 rpm

Homogenizer of type APV 1000, 3%, 200 bars

Physika MCR 301, measuring system CC 27, measuring cell C-PTD 200, 3%

Apparatuses used in the Examples 1 and 2:

Scales

Stopwatch

Voltage controller for adjusting the speed

Waring blender 1 L with glass top, e.g. model 38BC41 or HGB2W

Homogenizer of type APV 1000

Physika MCR 301, measuring system CC27, measuring cell C-PTD200

Annex 1

Description of measuring program: Physika MCR 301

| | |
|---|---|
| Measuring section 1 | Measuring method: |
| Load | Constant rotation, preliminary shearing |
| | Measuring profile: |
| | Shearing rate 3000 1/s |
| | Measuring points: 2 |
| | Measuring time: 5 min |
| Measuring section 2 | Measuring method: |
| Reconstruction | Oscillation structural reconstruction |
| | Measuring profile: |
| | Deformation: 1% constant |
| | Angular frequency: 10 1/s constant |
| | Measuring points: 600 |
| | Measuring time: 600 s (1 s/meas.point) |
| | constant specified time |
| | Evaluation: |
| | Storage modulus G′, loss modulus G″, |
| | loss factor tan□, crossing point G′ = G″ |

The samples described in the examples were measured and evaluated with the rheometer Physika MCR 301, measuring system CC27, measuring cell C-PTD200.

Annex 2

Description of the Testing Method for Illustrating Cocoa Milk

1. Fill 1,000 g of milk into the glass top of the Waring blender (originally weighed-in quantity of sample at room temperature).

2. Press button H12.

3. Start at 7000 to 8000 rpm (display 40 V on the measuring apparatus) and add the premixed dry matter (cocoa, 5 g; sugar, 60 g; and stabilizing agent). Prevent the material from reaching the glass wall.

4. Start the stopwatch and mix for a further 120 seconds at 40 V. 5. After 15 min of rising time, the suspension is homogenized at 200 bars; the cocoa suspension is stirred during the entire process (anchor agitator, 200 rpm) in order to ensure continuous uniformity of the concentration.

6. The homogenized and activated cocoa milk is filled into glass bottles and stored in the refrigerator at approximately 6° C.

7. The evaluation occurs after 24 hours and 48 hours. The cocoa milk will be shaken carefully again after 24 hours.

The glass bottles are examined visually for cocoa segmentation and photographed.

Annex 3

Performance of the sample preparation for the homogenizer:

Water stands for demineralized water and CaCl2 stands for enriched water.

Produce 1,000 g of a 3% dispersion.

1. Fill 1,000 g of water/milk into the glass top of the Waring blender (originally weighed-in quantity of sample at room temperature).

2. Press button HI2.

3. Start at 8000 to 10000 rpm (display 50 V on the measuring apparatus) and add 30 g abs. dry of the test sample. Prevent the material from reaching the glass wall.

4. Start the stopwatch and mix for a further 60 seconds. 5. Homogenize the 3% suspension at 200 bars; the 3% suspension is stirred during the entire process (anchor agitator, 200 rpm).

Annex 4

Performance of the sample preparation for Waring blender:

Water stands for demineralized water and CaCl2 stands for enriched water.

Produce 300 g of a 3% dispersion.

1. Fill 300 g of water/milk into the glass top of the Waring blender (originally weighed-in quantity of sample at room temperature).

2. Press button H12.

3. Start at 8000 to 10000 rpm (display 50 V on the measuring apparatus) and add 9 g abs. dry of the test sample. Prevent the material from reaching the glass wall.

4. Start the stopwatch and mix for a further 15 seconds.

5. Set 140-160 V (which corresponds to 18000 to 19000 rpm) and mix precisely for two minutes in order to ensure a continuous uniformity of the concentration.

What is claimed is:

1. A compound comprising:
microcrystalline cellulose (MCC) in colloidal form and two different qualities of carboxymethyl cellulose (CMC);
wherein the MCC and the two different qualities of CMC are combined by co-processing;
wherein the two different qualities of CMC have different degrees of substitution (DS), wherein a low-substituted CMC is present with a DS of 0.6 to 0.9 and a high-substituted CMC is present with a DS of 1.10 to 1.45;
wherein a percentage of CMC in the compound is between 5% and 18% by weight relating to a dry matter.

2. The compound of claim 1 wherein the co-processing is done by homogenization.

3. The compound of claim 1 wherein the MCC and the two different qualities of CMC are disposed in a waterous solution.

4. The compound of claim 3 wherein the co-processing is done by homogenization.

5. The compound of claim 1 wherein the compound is present in form of a gel having a gel strength of at least 25 Pa at a 3% application concentration relating to a medium in which the compound is dispersed, the gel obtained by homogenizing a compound powder.

6. The compound of claim 1 wherein the low-substituted CMC is present at a percentage of 30% to 70% and the high-substituted CMC is present at a percentage of 70% to 30%.

7. A method of making a compound, the method comprising:
providing microcrystalline cellulose (MCC) in colloidal form and two different qualities of carboxymethyl cellulose (CMC);
combining, by co-processing, the MCC and the two different qualities of CMC;
wherein the two different qualities of CMC have different degrees of substitution (DS), wherein a low-substituted CMC is present with a DS of 0.6 to 0.9 and a high-substituted CMC is present with a DS of 1.10 to 1.45;
wherein a percentage of CMC in the compound is between 5% and 18% by weight relating to a dry matter.

8. The method of claim 7 wherein the co-processing is done by homogenization.

9. The method of claim 7 wherein the MCC and the two different qualities of CMC are disposed in a waterous solution.

10. The method of claim 9 wherein the co-processing is done by homogenization.

11. The method of claim 7 wherein the compound is present in form of a gel having a gel strength of at least 25 Pa at a 3% application concentration relating to a medium in which the compound is dispersed, the gel obtained by homogenizing a compound powder.

12. The method of claim 7 wherein the low-substituted CMC is present at a percentage of 30% to 70% and the high-substituted CMC is present at a percentage of 70% to 30%.
